(19) United States
(12) Patent Application Publication
(10) Pub. No.: US 2015/0066779 A1
(43) Pub. Date: Mar. 5, 2015

(54) COMMUNICATION SYSTEM, A METHOD AND A DEVICE FOR REAL TIME MANAGEMENT, DATA ANALYSIS, TRACKING AND GEOGRAPHIC LOCATION OF BUSINESS DEALS

(71) Applicant: SHAILESH UPRETI, ITHACA, NY (US)

(72) Inventor: SHAILESH UPRETI, ITHACA, NY (US)

(21) Appl. No.: 14/475,519

(22) Filed: Sep. 2, 2014

Related U.S. Application Data
(60) Provisional application No. 61/872,839, filed on Sep. 2, 2013.

(51) Int. Cl. G06Q 20/40; G06Q 20/32; G06K 7/00

(52) U.S. Cl. CPC G06Q 20/4012; G06K 7/0004; G06Q 20/3223
USPC 705/72; 235/440

(57) ABSTRACT

Disclosed is a communication system, a method and a device for real time management, data analysis and geographic location of business deals. In one implementation, a system (100) for enabling a communication between at least two users (102) using said system (100), and a communication between at least one user and at least one payment processing server (110), using a specialized electronic card reader device (106) is disclosed. The system (100), a method (300), and the device (106) enabling team management, inventory management, payment processing and waste management tools to allow business owners, managers, employee and consumers to communicate within themselves and to the payment processing servers using single platform configured to allow business deals driven by real time management, data analysis and geographic location is disclosed. Further, the device (106) may be used for reading cards and the like and enabling multiple users to communicate with each other.

### TECHNICAL FIELD

The present subject matter described herein, in general, relates to providing banking services by use of a mobile communication system, and more particularly to a specialized device, a system, and a method enabling team management, inventory management, payment processing and waste management tools to allow business owners, managers, employee and consumers to communicate within themselves and to the payment processing servers using single platform configured to allow business deals driven by real time management, data analysis and geographic location.

### BACKGROUND

In the present days it has become a trend and a practice for implementing different business applications, such as applications for reserving rail and air tickets, applications for online shopping, applications for online payments of mobile/phone/internet bills, electricity bills, credit card bills, applications for online phone re-charge and applications for remotely monitoring any business operations and/or deals and the like. Users of such application systems generally update a database system on the mobile computing device through a synching operation with another central database of a server through either a wired or wireless network communication system. The synching operation makes the data, such as account information, accessible by the user of the mobile computing device.

Some business applications are designed to receive and process input relating to matters at various physical locations. For example, in the area of supply chain management (SCM), manufacturing, storage and/or transportation of products can be managed using a business system. For example, users at various positions in the supply chain can forward data relating to some aspect of the SCM and this information can be gathered by the business system and used for one or more purposes, such as to confirm that a product will be ready or delivered on time, or to make alternative arrangements when a delay occurs or is expected.

Mobile devices exist that can communicate with central computer systems over wide areas using any of multiple available wireless forms of communication. Typically, a client application for the mobile device will be developed to interact with a business system, either directly or via middleware. If the business system requires complex and sophisticated functionality by the mobile device, the client application may need to be very extensive and can occupy significant memory space on the mobile device. Moreover, to use more than one type or platform of mobile device the business may need to develop the client application separately for each type/platform. Replication and synchronization between business system and mobile devices typically require 3-tier architecture with complex middleware between the device and a business system.

The inventors of the present invention have done extensive research in this field and have come across applications for mobile payment processing, however no single application system has been found that allows multiple functionalities through single platform. It is worth noting that the challenge faced by the inventors was getting multiple functionalities through a single platform and the present inventors have been able to achieve a system and a method which would support such multiple functionalities as described under the field of the invention above to achieve through a single platform. Further the inventors have found that a unique solar power configured device for reading credit/debit card, cards such as magnetic, EMV (chip) or NFC or RFID or digital ones and the like can be attached to a computing device forming a unique system to adopt the application performing said multiple functionalities. Majority of current mobile applications need credit card number/name which can be easily stolen to run fraudulent transactions. Combination of hardware and software makes this solution unique in such a way that signature/secrete-pin are verified in real time to avoid any frauds and bring complete security and mobility to run business needs along with payment processing There are some patent documents which the inventors have come across and the same being discussed hereunder. However, it would be apparent to persons skilled in the art that the prior art documents do not throw any light on how multiple functionalities can be achieved on a single platform.

US20020092903 describes a method for managing method of managing delivery goods comprises the steps of receiving identification information for delivery goods entered by a deliverer when a recipient of the delivery goods is not at home, extracting delivery goods information and recipient information relevant to the delivery-goods identification information from a storage unit which stores the delivery goods information and the recipient information corresponding to the delivery goods information, and notifying the recipient of the delivery goods information based on the recipient information.

US20050097186 describes a method and system by which a central server resource can be accessed by mobile employees for managing data, in both a connected or disconnected environment. A combined local mirror website and connection proxy is provided on a mobile user device, to provide access to essentially all web content available from the central server, or to a predefined subset thereof, but in an environment when the device is disconnected from the central server.

U.S. Pat. No. 8,023,934 describes a system, method, and computer program product for synchronizing communications, data, application workflow events, and business processes between a mobile device and a server are described herein. In an embodiment, the method operates by determining whether there is a data object to be synchronized between a source and a target, wherein the source and target are one of either a mobile device or a server. An indication is sent to the target when there is a data object to be synchronized from the source. The data object to be synchronized is saved in a cache on the source and it is determined whether the mobile device is connected to the server. The synchronization operation is queued for the target until it is determined that the mobile device is connected to the server, and results are returned to the source after the data object is synchronized on the target. However, it was not known from this prior art that a unique network between users and merchants and banking system can be created in such a way that they not only manage their team, and/or inventory and/or waste and/or organizational branches, but also make secured payments using solar powered card reader and ultimately combines point of sale and social marketing together. It is not about how data flows between the points to run the business but utilizing networking patterns to execute business activities along with a secure payment processing.

U.S. Pat. No. 8,521,646 describes a system makes payments from a payer to a vendor and assesses a variable transaction fee to the vendor. The system comprises a database which associates, for each of a community of payers, identification a rate tier assigned to each vendor to which the payer makes payment. A tier assignment application determines a tier to assign to a vendor by determining: i) an industry sensitivity score based on the type of business the vendor operates; ii) a payer centric spend score; iii) a payer centric frequency score; iv) a network spend score; and iv) a network frequency score. The tier assigned to the vendor is a function of these scores. A payment application, when making payment from the payer to the vendor, determines a transaction fee to apply to the payment by multiplying the payment amount by a transaction rate associated with the tier assigned to the vendor.

U.S. Pat. No. 8,510,143 describes methods, systems, and apparatus, including computer program products, for implementing a software architecture design for a software application implementing ad-hoc goods movement. The application is structured as multiple process components interacting with each other through service interfaces, and multiple service operations, each being implemented for a respective process component. The process components include an Accounting process component that records the relevant business transactions for valuation and profitability analysis; an Inventory Processing process component that handles the management of inventory and the recording of inventory changes and may provide services to maintain current stock, handling unit content, logistics operating unit content, and allocation content; a Site Logistics Processing process component that handles the preparation, physical execution, and confirmation of logistics processes within a site; and a Supply and Demand Matching process component that combines the tasks necessary to ensure that sufficient material receipt elements exist to cover material demand while taking available capacity into account. However, the prior art is silent on inventory management and necessary tools to make transactions which would lead to a change in inventory and an automatic update in product listing without being someone dedicatedly managing the list of products.

The present invention relates broadly to a system and a method enabling team management, inventory management, payment processing and waste management tools to allow business owners, managers, employee and consumers to communicate within themselves and to the payment processing servers using single platform configured to allow business deals driven by real time management, data analysis and geographic location.

### BACKGROUND

First and foremost object of the present invention is to overcome the disadvantages/drawbacks of the known art.

A basic object of the present invention is to provide a system enabling team management, inventory management, payment processing and waste management tools to allow business owners, managers, employee and consumers to communicate within themselves and to the payment processing servers using single platform configured to allow business deals driven by real time management, data analysis and geographic location.

Another object of the present invention is to provide a method enabling team management, inventory management, payment processing and waste management tools to allow business owners, managers, employee and consumers to communicate within themselves and to the payment processing servers using single platform configured to allow business deals driven by real time management, data analysis and geographic location.

Another object of the present invention is to provide a specialized device for reading credit/debit card and the like and enabling team management, inventory management, payment processing and waste management tools to allow business owners, managers, employee and consumers to communicate within themselves and to the payment processing servers using single platform configured to allow business deals driven by real time management, data analysis and geographic location.

Another object of the present invention is to provide tracking of sales force on real time basis.

Another object of the present invention is to provide a system facilitating placement of orders by merchant's customers.

Another object of the present invention is to provide a system facilitating management of multiple branches.

Another object of the present invention is to provide a low energy electromagnetic radiation sensor based system enabling team management, inventory management, payment processing and waste management tools to allow business owners, managers, employee and consumers to communicate within themselves and to the payment processing servers using single platform configured to allow business deals driven by real time management, data analysis and geographic location.

Another object of the present invention is to provide a low energy electromagnetic radiation sensor based method enabling team management, inventory management, payment processing and waste management tools to allow business owners, managers, employee and consumers to communicate within themselves and to the payment processing servers using single platform configured to allow business deals driven by real time management, data analysis and geographic location.

Another object of the present invention is to provide an application system which can be used in any mobile device such as mobile phones, PCs, laptops, iPad's, tablets and the like.

Another object of the present invention is to provide mobility and security to current business models.

These and other advantages of the present invention will become readily apparent from the following detailed description read in conjunction with the accompanying drawings.

### SUMMARY OF THE INVENTION

The following presents a simplified summary of the invention in order to provide a basic understanding of some aspects of the invention. This summary is not an extensive overview of the present invention. It is not intended to identify the key/critical elements of the invention or to delineate the scope of the invention. Its sole purpose is to present some concept of the invention in a simplified form as a prelude to a more detailed description of the invention presented later.

In one aspect the present invention relates to a system enabling team management, inventory management, payment processing and waste management tools to allow business owners, managers, employee and consumers to communicate within themselves and to the payment processing servers using single platform configured to allow business deals driven by real time management, data analysis and geographic location.

In another aspect the present invention relates to a method enabling team management, inventory management, payment processing and waste management tools to allow business owners, managers, employee and consumers to communicate within themselves and to the payment processing servers using single platform configured to allow business deals driven by real time management, data analysis and geographic location.

In another aspect the present invention relates to a low energy electromagnetic radiation sensor based system enabling team management, inventory management, payment processing and waste management tools to allow business owners, managers, employee and consumers to communicate within themselves and to the payment processing servers using single platform configured to allow business deals driven by real time management, data analysis and geographic location.

In another aspect the present invention relates to a low energy electromagnetic radiation sensor based method enabling team management, inventory management, payment processing and waste management tools to allow business owners, managers, employee and consumers to communicate within themselves and to the payment processing servers using single platform configured to allow business deals driven by real time management, data analysis and geographic location.

In another aspect the present invention relates to a device for reading credit/debit card and the like and enabling team management, inventory management, payment processing and waste management tools to allow business owners, managers, employee and consumers to communicate within themselves and to the payment processing servers using single platform configured to allow business deals driven by real time management, data analysis and geographic location.

In another aspect the present invention relates to a system facilitating placement of orders by merchant's customers.

In another aspect the present invention relates to a system a system facilitating management of multiple branches.

In one implementation, a device for reading credit/debit card and the like and enabling team management, inventory management, payment processing and waste management tools to allow business owners, managers, employee and consumers to communicate within themselves and to the payment processing servers using single platform configured to allow business deals driven by real time management, data analysis and geographic location is disclosed.

In one implementation, a portable mobile electronics based dynamic application system designed to enable real time business management is disclosed. This would allow users to download application in their mobile or portable electronics devices and create product listing available for immediate sale and facilitate card-present type payment acceptance methods.

In one implementation, the system covers role assignment in team, adding discount coupons and post sale analysis. Merchants would be able to track their sales force in real time, take attendance digitally and monitor geographic locations of sale, process parallel orders and feed multiple payment modes such as cash, check, single or multiple cards.

In one implementation, using the proposed system, merchant's customer can also place orders through this application this application system and multiple branches are manageable by the Merchant on the same application platform.

In one implementation, the proposed system also includes low energy electromagnetic radiation based sensors in the form of eyeglasses, finger rings or wristwatch to add items to the cart. The system of the present invention further optionally includes voice activated commands to perform all different activities.

Accordingly, in one implementation, a system (100) for enabling a communication between at least two users (102) using said system (100), and a communication between at least one user and at least one payment processing server (110), using a specialized electronic card reader device (106) is disclosed. The system comprises of the said specialized electronic card reader device (106) configured to: read a payment card thereby receive said payment card details and a password form a user operating said specialized electronic card reader device; enable communication between at least two user using said system; and enable communication between said specialized electronic card reader device and said least one payment processing server. The system further comprises of the at least one payment processing server (110) configured to: receive read said payment card details and a password form a user operating said specialized electronic card reader device; and authenticate said user operating said specialized electronic card reader device.

In one implementation, a method (300) for enabling a communication between at least two users using a system (100), and a communication between at least one user and at least one payment processing server (110), using a specialized electronic card reader device (106) in said system (100) is disclosed. The method comprises of
receiving (302), using said specialized electronic card reader device, a payment card thereby receiving said payment card details and a password form a user operating said specialized electronic card reader device;
communicating (304), using said specialized electronic card reader device, the received payment card details and password to said least one payment processing server;
receiving (306), using at least one payment processing server, said communicated received payment card details and password;
authenticating (308), using at least one payment processing server, said user operating said specialized electronic card reader device.

In one implementation, a specialized electronic card reader device (106) for enabling a communication between at least two users (102) using said system (100), and a communication between at least one user and at least one payment processing server (110), in a system is disclosed. The specialized electronic card reader device (106) comprises of: at least one solar panel (1); at least one light emitting diode (LED) display (2); at least one chip card reader (3); at least one magnetic head (4); at least one encryption and central processing unit (CPU) (5); at least one near field communication (NFC) reader (6); mat least one battery (7); at least one audio jack (8); and at least one USB port (9).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE ACCOMPANYING DRAWINGS

The above and other aspects, features, and advantages of certain exemplary embodiments of the present invention will be more apparent from the following description taken in conjunction with the accompanying drawings in which:

FIG. 1 illustrates a network implementation of a system (100) for enabling a communication between at least two users (102) using said system (100), and a communication between at least one user and at least one payment processing server (110), using a specialized electronic card reader device (106) as shown, in accordance with an embodiment of the present subject matter.

FIG. 2 illustrates a block diagram of the system as shown, in accordance with an embodiment of the present subject matter.

FIG. 3 illustrates a method (300) for enabling a communication between at least two users (102) using said system (100), and a communication between at least one user and at least one payment processing server (110), using a specialized electronic card reader device (106) as shown, in accordance with an embodiment of the present subject matter.

FIG. 4 illustrates a flowchart of the overall working of the invention enabling a communication between at least two users (102) using said system (100), and a communication between at least one user and at least one payment processing server (110), as shown, in accordance with an embodiment of the present subject matter.

FIG. 5 illustrates an internal construction of a specialized electronic card reader device (106) as shown, in accordance with an embodiment of the present subject matter.

FIG. 6 illustrates an exterior view of the solar card reader as shown, in accordance with an embodiment of the present subject matter.

FIG. 7 illustrates an exterior view of the portable electromagnetic barcode, NFC, RFID, checkout device.

FIG. 8 illustrates internal construction of the portable electromagnetic barcode, NFC, RFID, checkout device.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure. Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary.

Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

The present invention describes a system based upon an n-tier, client-server architecture. The architecture will have secure managed interfaces or proxies to isolate systems from illegal access. The Architecture is a simple client-server system in which web technologies are used to provide forms from a simple server that can be filled in remotely by someone, for example, at a border post or in mobile devices. With a simple requirement to collect basic information, which can be entered as the user captures it. The access layer (client) caters for a range of terminals that may eventually need to access information. With enlargement, disclosed systems would handle a wide range of so-called ‘client’ systems ranging from simple mobile applications (Access) to information being collected from large-scale multi platform applications. Given this likely wide range of means of access, the current emphasis in client-server architectures of breaking down the architecture into several layers. Its key feature is that it separates out business logic, client access technology and centrally held data into discrete layers with standard, open interfaces. Today n-tier architectures can often be divided into several tiers as follows:
client or ‘access’ tier—which facilitates access by both external and internal clients through technologies such as mobile applications
presentation tier—the layer that accesses information from the other systems as required, and can contain its own ‘business rules’ for simple processes
business tier—contains the business information layer
persistence tier—the database layer, which provides the facilities to store data.

Depending upon the solution proposed for the system in question there may be a balance of functions placed into each of these layers. In the design process it is vital, however, to have a layered architecture as the basis of the solution to facilitate change and adaptation of the system in the future—in other words to protect the investment that has been made in the system as technologies develop in the future. The degree of isolation afforded to elements of the system through adopting a layered approach is significant and can help immunize the project from having to be replaced in full in years to come—some key elements will survive technological developments.

Infrastructure Services are provided to all applications with a view to reducing the time, cost and online threats. To gain full advantage of infrastructure services the requirements of all applications are strictly analyzed to meet Payment Card Industry (PCI) compliance requirements. The Infrastructure Services are built incrementally, implementing the most common requirements first, followed by more specialized services. Features covered in this section might include but not limited to: security, audits, performance monitoring and reporting, error handling, debugging, daily log reviews and 27X7 server monitoring, data backup in PCI compliance servers, antivirus installations, system integrity monitoring, dual factor authentication for server access, dedicated firewall, intrusion detection and intrusion prevention, vulnerability scanning and compliance, meet updated PCI compliance requirements, SSL Certificate implementation and data encryption, solar powered card reader, portable electromagnetic sensor.

In the present invention the present system is designed using UML and OOD based methodologies. One goal of OOD is to create a collection of reusable software objects that can be reused, in effect offering some significant savings in development costs. With the proposal to create a Reference Architecture a central library of objects could be reused across projects that have similar aims and objectives ‘to collect information’ but whose application areas vary.

While aspects of described a specialized device, a system, a method enabling team management, inventory management, payment processing and waste management tools to allow business owners, managers, employee and consumers to communicate within themselves and to the payment processing servers using single platform configured to allow business deals driven by real time management, data analysis and geographic location may be implemented in any number of different computing systems, environments, and/or configurations, the embodiments are described in the context of the following exemplary system.

Another embodiment of the present invention describes a device for reading credit/debit card and the like and enabling team management, inventory management, payment processing and waste management tools to allow business owners, managers, employee and consumers to communicate within themselves and to the payment processing servers using single platform configured to allow business deals driven by real time management, data analysis and geographic location. The card reader comprises a solar panel and is attachable to electronic devices like 3.5 mm audio jack, USB or wireless communication including but not limited to wi-fi or Bluetooth. The device optionally comprises pin pad for entering digital verification code thus making the system more secured for transaction/fee processing and the like.

The methodology and techniques described with respect to the aforesaid embodiments can be performed using a machine or other computing device within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in a server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The machine may include a processor (e.g., a central processing unit (CPU), a graphics processing unit (GPU, or both), a main memory and a static memory, which communicate with each other via a bus. The machine may further include a video display unit (e.g., a liquid crystal displays (LCD), a flat panel, a solid state display, or a cathode ray tube (CRT)). The machine may include an input device (e.g., a keyboard) or touch-sensitive screen, a cursor control device (e.g., a mouse), a disk drive unit, a signal generation device (e.g., a speaker or remote control) and a network interface device.

The disk drive unit may include a machine-readable medium on which is stored one or more sets of instructions (e.g., software) embodying any one or more of the methodologies or functions described herein, including those methods illustrated above. The instructions may also reside, completely or at least partially, within the main memory, the static memory, and/or within the processor during execution thereof by the machine. The main memory and the processor also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network via the network interface device.

While the machine-readable medium can be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: tangible media; solid-state memories such as a memory card or other package that houses one or more read-only (non-volatile) memories, random access memories, or other re-writable (volatile) memories; magneto-optical or optical medium such as a disk or tape; non-transitory mediums or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

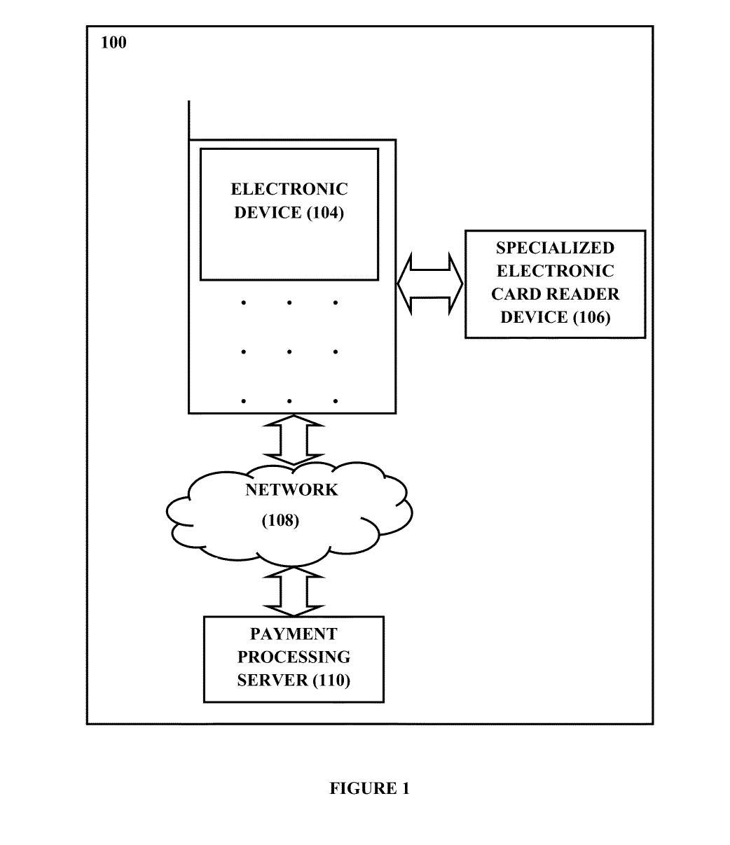

Referring now to FIG. 1, illustrates a network implementation of a system (100) for enabling a communication between at least two users (102) using said system (100), and a communication between at least one user and at least one payment processing server (110), using a specialized electronic card reader device (106) as shown, in accordance with an embodiment of the present subject matter.

In one implementation, although the present invention is explained considering that it is implemented for enabling a communication between at least two users (102) using said system (100), and a communication between at least one user and at least one payment processing server (110), using a specialized electronic card reader device (106), it may be understood that the present invention may also be implemented in a variety of computing systems, such as a laptop computer, a desktop computer, a notebook, a workstation, a mainframe computer, a server, a network server, and the like. It will be understood that the electronic device (104) may be accessed by multiple users (102) (not shown in figure), or applications residing on the electronic device (104). Examples of the electronic device (104) may include, but are not limited to, a portable computer, a personal digital assistant, a handheld device, and a workstation. The electronic device (104) may be communicatively coupled to one or other devices used by users (102) and also to the specialized electronic card reader device (106) using a network (108), and/or directly and one or more databases.

In one implementation, the network (108) may be a wireless network, a wired network or a combination thereof. The network can be implemented as one of the different types of networks, such as intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network may include a variety of network devices, including routers, bridges, servers, computing devices, storage devices, and the like.

In one implementation, the specialized electronic card reader device (106) and the electronic device (104) may include a user interface (not shown) or interface/s may include a variety of software and hardware interfaces, for example, a web interface, a graphical user interface, and the like. The user interface may allow the users (102) to interact with the specialized electronic card reader device (106) and the electronic device (104) directly or through the other devices. Further, the user interface may enable the electronic device (104) to communicate with other the electronic device (104), such as web servers and external data servers. The user interface may facilitate multiple communications within a wide variety of networks and protocol types, including wired networks, for example, LAN, cable, etc., and wireless networks, such as WLAN, cellular, or satellite. The I/O interface may include one or more ports for connecting a number of devices to one another or to another server.

In one implementation, the specialized electronic card reader device (106) and the electronic device (104) may be implemented as one or more microprocessors, microcomputers, microcontrollers, digital signal processors, central processing units, state machines, logic circuitries, and/or any devices that manipulate signals based on operational instructions. Among other capabilities, the processor (106) or the CPU of the specialized electronic card reader device (not shown) is configured to fetch and execute computer-readable instructions stored in the memory (not shown).

In one implementation, the memory may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

In one implementation, the modules stored in the memory include routines, programs, objects, components, data structures, etc., which perform particular tasks or implement particular abstract data types. In one implementation, the modules may include may include programs or coded instructions that supplement applications and functions of the specialized electronic card reader device (106) and the electronic device (104).

In one implementation, a system (100) for enabling a communication between at least two users (102) using said system (100), and a communication between at least one user and at least one payment processing server (110), using a specialized electronic card reader device (106) is disclosed. The system comprises of the said specialized electronic card reader device (106) configured to: read a payment card thereby receive said payment card details and a password form a user operating said specialized electronic card reader device; enable communication between at least two user using said system; and enable communication between said specialized electronic card reader device and said least one payment processing server. The system further comprises of the at least one payment processing server (110) configured to: receive read said payment card details and a password form a user operating said specialized electronic card reader device; and authenticate said user operating said specialized electronic card reader device.

In one implementation, the said specialized electronic card reader device (106) receives read said payment card instructions from a user (102).

In one implementation, said specialized electronic card reader device (106) receives read said payment card instructions from at least one sensor, wherein said at least one sensor is configured to read said payment card and converts the read data in a readable format.

In one implementation, said specialized electronic card reader device (106) communicate with said least one payment processing server (110) by sending said payment card details and said password of said user operating said specialized electronic card reader device (106).

In one implementation, at least one payment processing server (110) is further configured to store data related to at least one users information, geographical position of said at least one user while reading said payment card, said payment card details and said password received while reading said payment card.

In one implementation, said stored data in said at least one payment processing server (110) is used to authenticate said user operating said specialized electronic card reader device (106).

In one implementation, the system (100) enables said at least one user selected form a team management, an inventory management, a payment processing management and waste management tools to communicate with said at least one user selected form business owners, managers, employee and consumers within themselves and further to said at least one payment processing servers using said specialized electronic card reader device to allow business deals driven by real time management, data analysis and geographic location.

In one implementation, said specialized electronic card reader device (106) is capable of connecting to an electronic device (102) and thereby enable said communication electronic device (102).

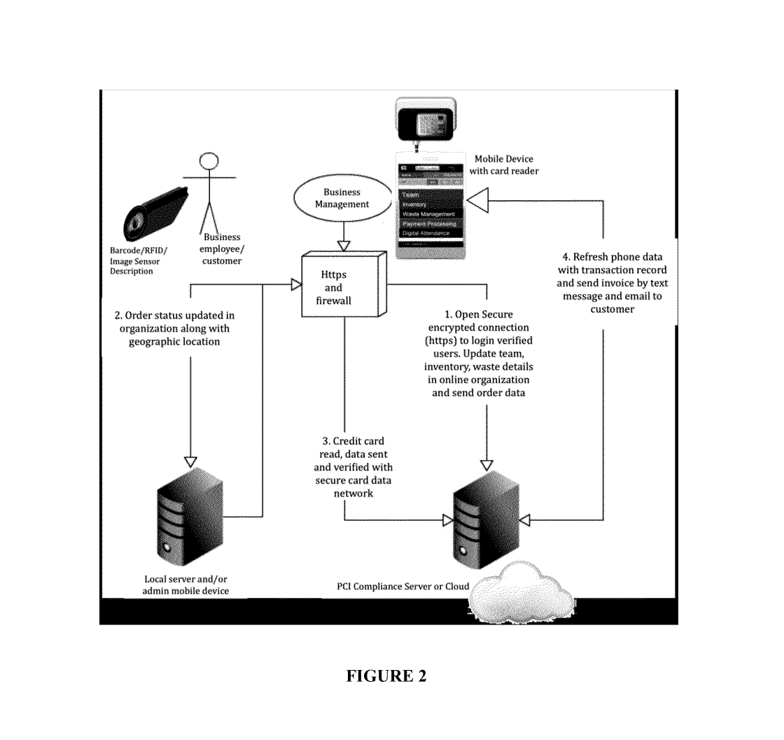

Referring now to FIG. 2, illustrates a block diagram of the system as shown, in accordance with an embodiment of the present subject matter. In one implementation, as shown in figure, the system reads the credit/debit card either from a magnetic strip or a chip or wireless signals from NFC/RFID. Magnetic card is magnetically active material that saves the user data in magnetic particles. Sensor reads that data and convert it into a readable format. Similarly when chip bases card is inserted, electrodes from card reader power it and the data saved in digital format is read and converted in readable format on mobile phone screen. Mobile is connected to card reader by the technology that may include but not limited to Bluetooth or audio jack or USB or wi-fi or RFID or any form of electromagnetic wireless wave and the like. This system in some cases would be powered by a rechargeable battery and sometime it can harvest energy directly from solar panel and sometime it can also convert sound energy electrical energy to power up the sensors, especially when connected using phone audio jack.

In one implementation, different sensors may read different type of credit/debit card. The sensors may include to any of the known sensors available in the prior-art for reading card/debit card. Once the sensor reads data, the hardware encryption may be applied in order to protect the theft. Then the encrypted data may be transmitted to an electronic device like phone or tablet or laptop. From there it is send to payment gateways for payment approval etc. and we get confirmation or denial message back from the bank. From there the system may send the data received to payment gateways for payment approval and other formalities known as per the current market authentication security and based on this the system may further provide confirmation or denial message back from the bank.

In one implementation, the specialized device (106) may be a portable and easy to carry along, so it also falls under the category called mobile point of sale. Further, one of the most unique features about the specialized device (106) is a solar charger on surface which enables the device to be solar chargeable and hence economical and eco-friendly. Due to this special feature of the specialized device (106) it may be categorized under photovoltaic device.

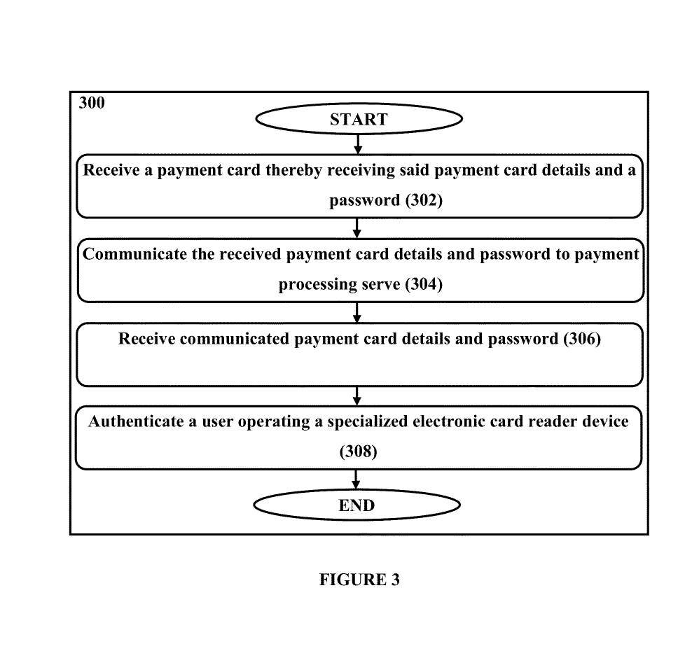

FIG. 3 illustrates a method (300) for enabling a communication between at least two users (102) using said system (100), and a communication between at least one user and at least one payment processing server (110), using a specialized electronic card reader device (106) as shown, in accordance with an embodiment of the present subject matter. In one implementation, the method (300) may be described in the general context of computer executable instructions. Generally, computer executable instructions can include routines, programs, objects, components, data structures, procedures, modules, functions, etc., that perform particular functions or implement particular abstract data types. The method (300) may also be practiced in a distributed computing environment where functions are performed by remote processing devices that are linked through a communications network. In a distributed computing environment, computer executable instructions may be located in both local and remote computer storage media, including memory storage devices.

The order in which the method (300) is described is not intended to be construed as a limitation, and any number of the described method blocks can be combined in any order to implement the method (300) or alternate methods. Additionally, individual blocks may be deleted from the method (300) without departing from the protection scope of the subject matter described herein. Furthermore, the method can be implemented in any suitable hardware, software, firmware, or combination thereof. However, for ease of explanation, in the embodiments described below, the method (300) may be considered to be implemented in the above described system (100).

At block 302, a payment card is received and said payment card details and a password form a user is received. In one implementation, a payment card is received using said specialized electronic card reader device and said payment card details and a password form a user operating said specialized electronic card reader device is received.

At block 304, the received payment card details and password are communicated. In one implementation, the received payment card details and password are communicated to the least one payment processing server by using said specialized electronic card reader device.

At block 306, said communicated received payment card details and password are received. In one implementation, said communicated received payment card details and password are received using at least one payment processing server.

At block 308, said user operating said specialized electronic card reader device is authenticated. In one implementation, said user operating said specialized electronic card reader device is authenticated using at least one payment processing server.

In one implementation, the method further enables communication, using said specialized electronic card reader device (106), between at least two users using said system. In one implementation, multiple users may communicate using the electronic device (104) or may communicate the using specialized electronic card reader device (106) via. Electronic device (104).

In one implementation, the method (300) enables said at least one user selected form a team management, an inventory management, a payment processing management and waste management tools to communicate with said at least one user selected form business owners, managers, employee and consumers within themselves and further to said at least one payment processing servers using said specialized electronic card reader device to allow business deals driven by real time management, data analysis and geographic location.

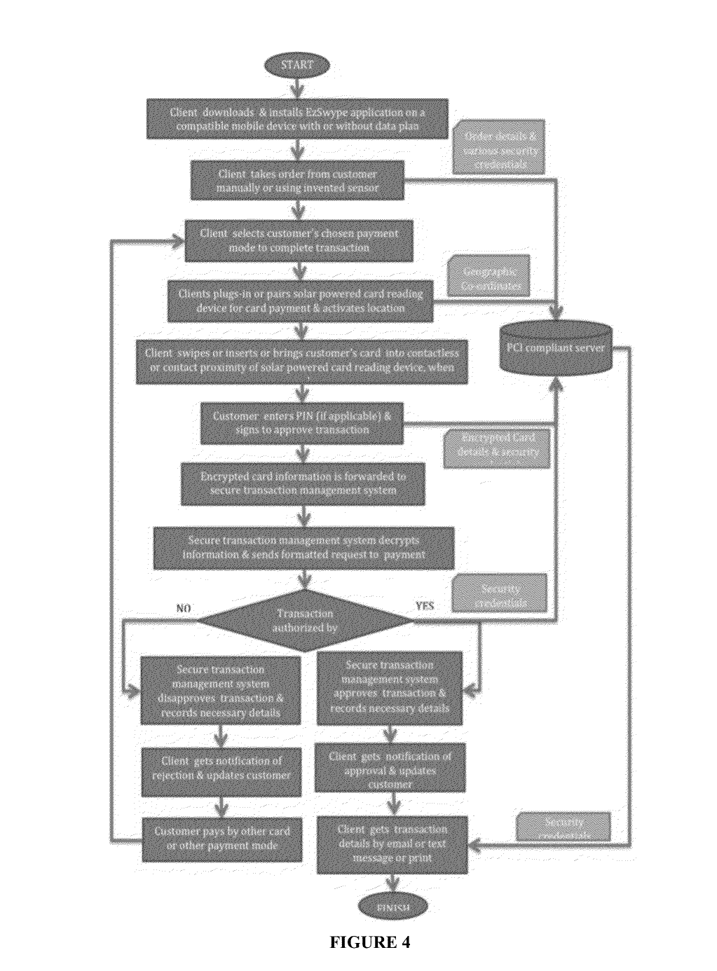

FIG. 4 illustrates a flowchart of the overall working of the invention enabling a communication between at least two users (102) using said system (100), and a communication between at least one user and at least one payment processing server (110), as shown, in accordance with an embodiment of the present subject matter. In one exemplary embodiment let's assume XYZ is a grocery store owner who heard about the present invention and opts to use it. The first thing he will do is to download the application i.e., the present invention on a compatible phone that may include but not limited to android or iOS phone with some basic requirements for application's full functionality. This compatible phone may have a data plan which helps XYZ use the application anywhere he goes or just have wi-fi compatibility, so he can use the application wherever he has secure wi-fi connectivity only. Once XYZ has downloaded the application he registers himself with the present invention. Three stage registration and verification process is completed for him by the present invention before he can accept card payment using the present invention application and hardware. Once the present invention is verified to be a genuine merchant he can now accept payments using card reader.

As per a step of the present invention it takes order from his customer using the present invention app or manually using pen and paper or using the invented sensor which detects RFID of the items that the customer picked and automatically adds them to his order. When order is complete XYZ asks the customer if he would like to pay by cash, cheque or card and selects that payment mode in the present invention app on his phone. For cash and cheque payments, XYZ simply completes all details using application and forwards customer's order receipt via email or text message or a printed copy.

For card payments, XYZ plugs in (through the audio jack) or pairs (via Bluetooth or NFC) the invented solar powered (charged using solar energy instead of conventional electricity) card reading device with his phone. If location tracking on his phone is turned off, he is asked to turn it on so the present invention application can track the geographical co-ordinates of the card reader's physical location. Customer is asked to swipe (for magnetic cards) or insert (for EMV cards) or bring card in close proximity of the card reader (for NFC cards; this may be contact-less as in the METRO cards or with contact i.e. simple touch with the reader) when the card reader is ready. For cards requiring customer's PIN to process a transaction, customer is asked to enter the PIN using the present invention application, followed by his signatures on XYZ's phone.

Encrypted card information is now sent to the present invention processor (national/local banks) who then forwards it to the card issuing company (VISA/MASTERCARD/DISCOVER/AMERICAN EXPRESS etc.) for processing (approving/rejecting) the transaction. If approved, XYZ gets an approval message with approval code from his processor (bank) and tells customer that transaction has been approved and offers to send transaction receipt via email or text message or provide a printed copy. Customer's chosen way to get receipt is followed.

However, if the transaction is declined by the card issuing company, XYZ gets denial from his processor. XYZ then asks customer to choose a different card or different mode of payment (cash or cheque) and entire process is followed.

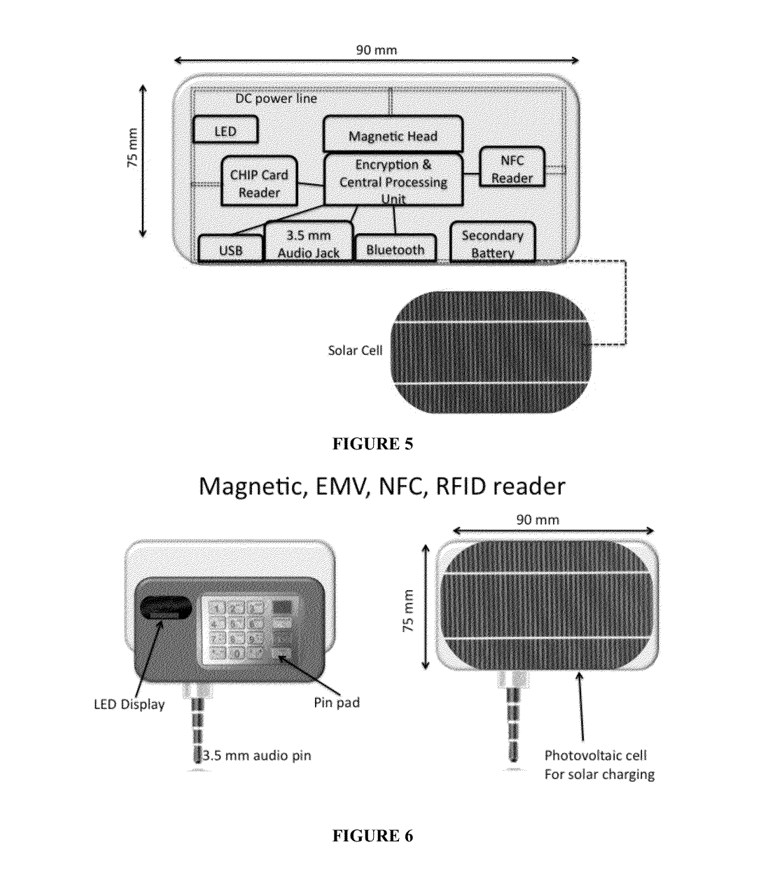

FIG. 5 illustrates an internal construction of a specialized electronic card reader device (106) as shown, in accordance with an embodiment of the present subject matter. In one implementation, a specialized electronic card reader device (106) for enabling a communication between at least two users (102) using said system (100), and a communication between at least one user and at least one payment processing server (110), in a system is disclosed. The specialized electronic card reader device (106) comprises of: at least one solar panel (1); at least one light emitting diode (LED) display (2); at least one chip card reader (3); at least one magnetic head (4); at least one encryption and central processing unit (CPU) (5); at least one near field communication (NFC) reader (6); mat least one battery (7); at least one audio jack (8); and at least one USB port (9).

In one implementation, said at least one solar panel, said at least one light emitting diode (LED) display, said at least one chip card reader, said at least one magnetic head, said at least one encryption and central processing unit (CPU), said at least one near field communication (NFC) reader, said at least one audio jack, and said at least one USB port are communicably coupled with each other, and said at least one battery is configured to provide a power for working of said specialized electronic card reader device.

In one implementation, the specialized electronic card reader device (106) may include a pin pad that may be used to provide input to the device (106) thereby initiating the communication. In one example, the input may be the user name and password of the user operating the specialized electronic card reader device (106) thereby triggering the specialized electronic card reader device (106) to transmit the data to the server for authentication. In one example, the input may be used for initiating the communication between the two users on the same platform using the system.

In one implementation, the method (300) enables reading of at least one payment card, and said enables at least one user selected form a team management, an inventory management, a payment processing management and waste management tools to communicate with said at least one user selected form business owners, managers, employee and consumers within themselves and further to said at least one payment processing servers using said specialized electronic card reader device to allow business deals driven by real time management, data analysis and geographic location.

In one implementation, the specialized electronic card reader device (106) may be attachable to at least one electronic device by using an audio jack, a USB or wireless communication.

In one implementation, said specialized electronic card reader device (106) is capable of connecting to an electronic device (102) and thereby enable said communication electronic device (102).

In one implementation, said at least one solar panel (1) is configured to generate power from solar energy and thereby enabling said specialized electronic card reader device (106) to work as a photovoltaic device.

In one implementation, the solar panel may be used to provide energy to device to activate the sensors or to charge the battery.

In one implementation, the at least one light emitting diode (LED) display is to display the characters read by sensors, like masked card data or masked password or text display to confirm that the sensors are functioning.

In one implementation, the at least one chip card reader is like digital data readers, something like a reader in computer which can retrieve data from hard disk or pen drive etc. It may be used in order to access files saved in Chip or EMV bases credit cards, this sensor also apply relevant voltage to the chip to power it up and that is how then reader part of the sensors reads the data.

In one implementation, the at least one magnetic head may be the sensors that readers the black magnetic strip we see back of the credit/debit cards, mostly data is saved in magnetic domains and sensor reads those domains. There might be thousand millions of such domain in each track and usually cards contain 3 tracks.

In one implementation, the at least one encryption may be the hardware that apply encryption on card data so that the original format, which contains sensitive data, doesn't get stolen while electronic device send it to payment gateways.

In one implementation, the central processing unit (CPU) is the brain of the system as it may controls all the activities of various communication ports, or sensors or energy storage unit like battery or energy generation unit like photovoltaic pad or solar panel.

In one implementation, the at least one near field communication (NFC) reader may be the sensor which would read electromagnetic data from new types of wireless card, its similar to metro card operates or activated when external magnetic field is applied, then this sensor would read data saved in the chip without touching the chip, it is also called contactless communication.

In one implementation, the at least one audio jack is 3.5 mm audio cable that is used to listen to the music. This sensor would take the audio signal and then convert it into digital data, any sensor can pass on data to this port for communication and it can convert audio to digital or digital to audio for two way communication between electronic device and card reader).

In one implementation, the at least one USB port may be usual USB like personal computer or mini USB used in mobile phones, this can also be used to charge the battery inside the device in case needed be from external electricity source are communicably coupled with each other, and said at least one battery is configured to provide a power for working of said specialized electronic card reader device.

FIG. 6 illustrates an exterior view of the solar card reader as shown, in accordance with an embodiment of the present subject matter. As shown in figure, the specialized electronic card reader device (106) includes at least one photovoltaic device and hence may be referred to as a solar card reader device.

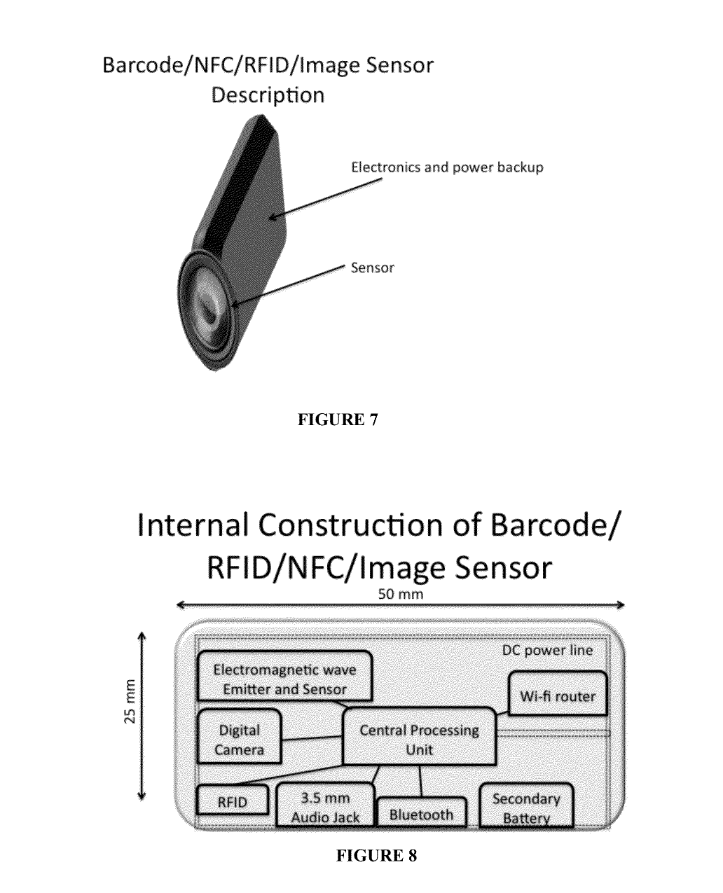

FIG. 7 illustrates an exterior view of the portable electromagnetic barcode, NFC, RFID, checkout device.

FIG. 8 illustrates internal construction of the portable electromagnetic barcode, NFC, RFID, checkout device.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Thus, although specific arrangements have been illustrated and described herein, it should be appreciated that any arrangement calculated to achieve the same purpose may be substituted for the specific arrangement shown. This disclosure is intended to cover any and all adaptations or variations of various embodiments and arrangements of the invention. Combinations of the above arrangements, and other arrangements not specifically described herein, will be apparent to those of skill in the art upon reviewing the above description.

I claim:

1. A system (100) for enabling a communication between at least two users (102) using said system (100), and a communication between at least one user and at least one payment processing server (110), using a specialized electronic card reader device (106), said system CHARACTERIZED IN THAT comprising:
said specialized electronic card reader device (106) configured to:
read a payment card thereby receive said payment card details and a password form a user operating said specialized electronic card reader device;
enable communication between at least two user using said system; and
enable communication between said specialized electronic card reader device and said least one payment processing server; and
said at least one payment processing server (110) configured to:
receive read said payment card details and a password form a user operating said specialized electronic card reader device; and
authenticate said user operating said specialized electronic card reader device.

2. The system (100) as claimed in claim 1, wherein said specialized electronic card reader device (106) receives read said payment card instructions from a user (102).

3. The system (100) as claimed in claims 1 and 2, wherein said specialized electronic device (106) reads product checkout instructions from at least one sensor, wherein said at least one sensor is configured to read said product attributes and converts the read data in a readable format.

4. The system (100) as claimed in claims 1 and 2, wherein said specialized electronic device (106) reads product checkout instructions from at least one sensor and used in applications not limiting to point of sale checkout, digital attendance system, product tracking, postal tracking, inventory tracking, ticketing, security monitoring, payment processing, payment authentication, biometric data reading, car tracking, toll payment, office attendance, school attendance, and

5. The system (100) as claimed in claims 1 and 2, wherein said specialized electronic card reader device (106) receives read said payment card instructions from at least one sensor, wherein said at least one sensor is configured to read said payment card and converts the read data in a readable format.

6. The system (100) as claimed in claims 1 to 3, wherein said specialized electronic card reader device (106) communicate with said least one payment processing server (110) by sending said payment card details and said password of said user operating said specialized electronic card reader device (106).

7. The system (100) as claimed in claims 1 to 4, wherein at least one payment processing server (110) is further configured to store data related to:
said at least one users information, geographical position of said at least one users while reading said payment card, said payment card details and said password received while reading said payment card.

8. The system (100) as claimed in claims 1 to 5, wherein said stored data in said at least one payment processing server (110) is used to authenticate said user operating said specialized electronic card reader device (106).

9. The system (100) as claimed in claims 1 to 6, enables said at least one user selected form a team management, an inventory management, a payment processing management and waste management tools to communicate with said at least one user selected form business owners, managers, employee and consumers within themselves and further to said at least one payment processing servers using said specialized electronic card reader device to allow business deals driven by real time management, data analysis and geographic location.

10. The system (100) as claimed in claims 1-7, wherein said specialized electronic card reader device (106) is capable of connecting to an electronic device (102) and thereby enable said communication electronic device (102).

11. A method (300) for enabling a communication between at least two users using a system (100), and a communication between at least one user and at least one payment processing server (110), using a specialized electronic card reader device (106) in said system (100), said method CHARACTERIZED IN THAT comprising:
receiving (302), using said specialized electronic card reader device, a payment card thereby receiving said payment card details and a password form a user operating said specialized electronic card reader device;
communicating (304), using said specialized electronic card reader device, the received payment card details and password to said least one payment processing server;
receiving (306), using at least one payment processing server, said communicated received payment card details and password;
authenticating (308), using at least one payment processing server, said user operating said specialized electronic card reader device.

12. The method (300) as claimed in claims 8 and 9 further comprises of enabling communication, using said specialized electronic card reader device (106), between at least two users using said system.

13. The method (300) as claimed in claims 8 to 10, enables said at least one user selected form a team management, an inventory management, a payment processing management and waste management tools to communicate with said at least one user selected form business owners, managers, employee and consumers within themselves and further to said at least one payment processing servers using said specialized electronic card reader device to allow business deals driven by real time management, data analysis and geographic location.

14. A specialized electronic card reader device (106) for enabling a communication between at least two users (102) using said system (100), and a communication between at least one user and at least one payment processing server (110), in a system, said specialized electronic card reader device (106) CHARACTERIZED IN THAT comprising:
at least one solar panel (1);
at least one light emitting diode (LED) display (2);
at least one chip card reader (3);
at least one magnetic head (4);
at least one encryption and central processing unit (CPU) (5);
at least one near field communication (NFC) reader (6);
at least one battery (7);
at least one audio jack (8); and
at least one USB port (9).

15. The specialized electronic card reader device (106) as claimed in claim 12, wherein said at least one solar panel, said at least one light emitting diode (LED) display, said at least one chip card reader, said at least one magnetic head, said at least one encryption and central processing unit (CPU), said at least one near field communication (NFC) reader, said at least one audio jack, and said at least one USB port are communicably coupled with each other, and said at least one battery is configured to provide a power for working of said specialized electronic card reader device.

16. The specialized electronic card reader device (106) as claimed in claims 12 and 13 comprises a pin pad.

17. The specialized electronic card reader device (106) as claimed in claims 12 to 14 enables reading of at least one payment card, and said enables at least one user selected form a team management, an inventory management, a payment processing management and waste management tools to communicate with said at least one user selected form business owners, managers, employee and consumers within themselves and further to said at least one payment processing servers using said specialized electronic card reader device to allow business deals driven by real time management, data analysis and geographic location.

18. The specialized electronic card reader device (106) as claimed in claims 12 to 15 is attachable to at least one electronic device by using an audio jack, a USB or wireless communication.

19. The specialized electronic card reader device (106) as claimed in claims 12 to 16, wherein said specialized electronic card reader device (106) is capable of connecting to an electronic device (102) and thereby enable said communication electronic device (102).

20. The specialized electronic card reader device (106) as claimed in claims 12 to 17, wherein said at least one solar panel (1) is configured to generate power from solar energy and thereby enabling said specialized electronic card reader device (106) to work as a photovoltaic device.
